(19) United States
(12) Patent Application Publication
(10) Pub. No.: US 2015/0060574 A1
(43) Pub. Date: Mar. 5, 2015

(54) OVERMOLDED COMPONENT WITH A LABYRINTH SEAL

(71) Applicant: ROBERT BOSCH GMBH, Stuttgart (DE)

(72) Inventor: Ralf Kromer, Vaihingen (DE)

(73) Assignee: Robert Bodch GmbH, Stuttgart (DE)

(21) Appl. No.: 14/386,119

(22) PCT Filed: Feb. 18, 2013
(86) PCT No.: PCT/EP2013/053210

§ 371 Date: Sep. 18, 2014

(30) Foreign Application Priority Data
Mar. 19, 2012 (DE) 102012204302.0

(51) Int. Cl. F02M 63/00; B29C 63/00; B29D 99/00; F02M 61/16

(52) U.S. Cl. CPC F02M 63/007; F02M 61/166; B29C 63/0056; B29D 99/0053; B29C 2063/006; B29K 2101/00
USPC 239/584; 428/172; 264/274

(57) ABSTRACT

A component having an insert part and an overmold that extends at least partly around the insert part, the insert part having at least one groove and the groove having an undercut at at least one edge, and the overmold at least partly filling the groove.

### FIELD OF THE INVENTION

The present invention relates to a component that is overmolded with another material. In addition, the present invention relates to a method for producing an overmolded component, and to a fuel injection device for an internal combustion engine that includes an overmolded component according to the present invention.

### BACKGROUND INFORMATION

Components overmolded in particular with plastic are known from the existing art, where the problem constantly occurs that due to different coefficients of expansion micro-gaps arise between the component and the overmold. Due to these uptight places, and promoted by the capillary effect, liquid and gaseous media can penetrate between the component and the overmold and can cause corrosion. In order to counter this problem, especially in the case of turned parts it is known to make two or three straight punctures in the surface that is to be overmolded, according to the principle of labyrinth sealing. However, here as well it has turned out that due to the different coefficients of expansion micro-gaps arise, so that adequate tightness cannot be ensured.

However, particularly in the case of components that are subject to frequent and large temperature fluctuations, it is desirable that the overmold lie tightly against the base part.

### SUMMARY OF THE INVENTION

The component according to the present invention as described herein includes an insert part and an overmold. Here, the overmold extends at least partly around the insert part. In order to prevent the penetration of gaseous or liquid media between the insert part and the overmold, the insert part has at least one groove, and at least one edge of the groove has an undercut. The groove is in addition at least partly filled by the overmold in order in this way to seal the insert part against the overmold. Through the undercut of the groove, the bonding of the overmold to the insert part is improved. Due to this anchoring of the overmold in the insert part, the formation of micro-gaps is prevented, even given different coefficients of expansion or changing temperature influences, thus increasing tightness in comparison with the existing art.

The further descriptions herein relate to further developments of the present invention.

In a specific embodiment of the present invention, the groove is realized with a spiral shape. In this way, the production process is simplified, because the spiral shape can be produced in one working step. Alternatively, it may be provided that the groove is realized so as to be closed on itself, in particular having an annular shape. In this alternative, it may be provided that a plurality of grooves are situated parallel to one another. Therefore, this variant enables an optimal production process mainly in the case of small surfaces that are to be overmolded.

Advantageously, the undercut is made in at least one of the edges of the groove in such a way that, in a sectional view, the edge and the floor surface of the groove form an acute angle. In particular, it may be provided that both edges of the groove form an acute angle with the floor surface. Here, the floor surface of the groove need not necessarily be made planar, but can be provided as an angled configuration, in particular having two regions of the floor surface oriented toward the outer side of the groove. Given such an angled configuration, the anchoring of the overmold in the insert part is improved, thus increasing the tightness.

It may be provided that the groove is completely filled by the overmold. Because in this way all the surfaces of the groove are covered by the overmold, the achievable tightness is maximized.

In an advantageous specific embodiment of the present invention, the insert part is a turned part. This has the particular advantage that the groove can be made in the insert part through a simple assembly step. Both for the spiral groove and for the closed, in particular annular groove, turning is the optimal production method.

The insert part may be made from a metallic material. In contrast, the overmold may be made of a plastic. Advantageously, in this way the basic shape of a metallic insert part can be easily expanded at low cost through the plastic overmold.

Moreover, the present invention relates to a method for producing an overmolded component, including the following steps: as starting point, an insert part is provided in which a groove is made. Here, the groove has an undercut at at least one edge. Subsequently, the insert part is overmolded with a further material, the overmold at least partly filling the groove that is made. Here, the material is also sprayed into the undercuts of the groove, thereby anchoring the hardened overmold on the insert part. Therefore, this method is a simple production method by which tightly overmolded components can be produced.

The groove may be made in the jacket surface of the insert part with a spiral shape or with an annular shape. In particular in the case of long grooves, the spiral shape has the advantage that it can be produced in a continuous production step. The annular shape is an easy-to-produce alternative that can be used for small overmolded lengths. Here, it may be provided that a plurality of annular grooves are made parallel to one another in the insert part.

In a specific embodiment, the groove is made in the insert part using a tool, the tool having a blade offset that corresponds to one or more groove spacings. In this way, an undercut can be realized at both edges of the groove very easily. However, as a simple, low-cost alternative, a tool not having a blade offset can also be used.

In addition, the present invention relates to a fuel injection device for an internal combustion engine as described herein. Here, the fuel injection device includes a component according to the present invention as described above. The component according to the present invention is advantageously used in the fuel injection device, because here a component is required that has a plastic overmold that has to lie tightly on the base part at all times. Here, the component is exposed to large temperature fluctuations which however must not impair the tightness between the base part and the overmold.

In the following, exemplary embodiments of the present invention are described in detail with reference to the accompanying drawings.

### BRIEF DESCRIPTION OF THE DRAWINGS

FIG. 1 shows a schematic view of the component according to an exemplary embodiment of the present invention.

FIG. 2 shows a schematic view of a groove of a component according to the exemplary embodiment of the present invention.

FIG. 3 shows an enlarged representation of a region of the groove of FIG. 2.

FIG. 4 shows a schematic representation of a cutting process using a tool in order to make the groove in an insert part according to the exemplary embodiment of the present invention.

FIG. 5 shows a schematic representation of an injection valve that includes the component according to the exemplary embodiment of the present invention.

### DETAILED DESCRIPTION

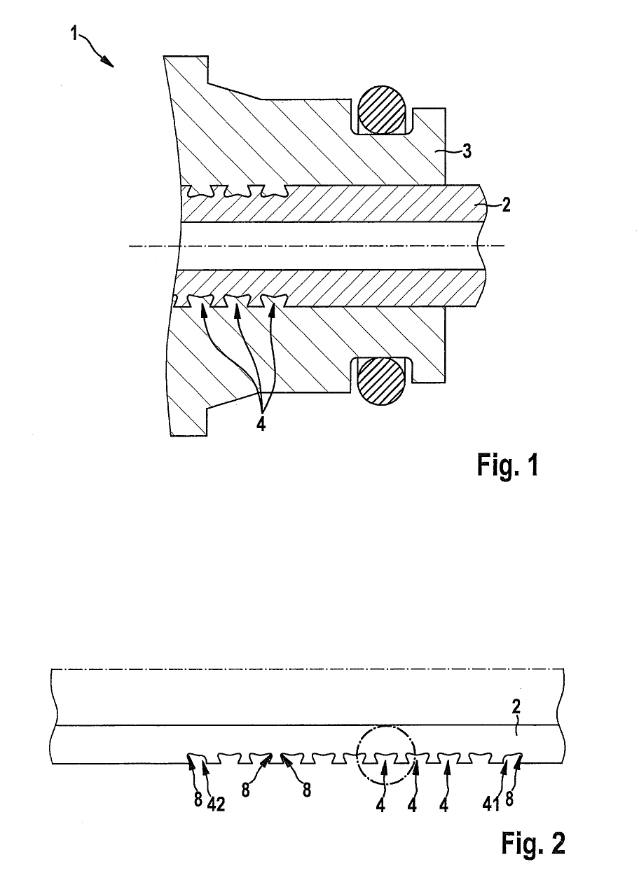

FIG. 1 shows a sectional view of component 1 according to the present invention, which includes an insert part 2 and an overmold 3.

Insert part 2 may be a turned part made of a metallic material, while overmold 3 may be made of plastic. In order to ensure tightness between insert part 2 and overmold 3, a groove 4 is present on insert part 2. Groove 4 can either have a spiral shape or can be closed with an annular shape. In order to improve the tightness and to increase the hold of the overmold on the insert part, the groove has an undercut 8 at two edges that is filled by the overmold. In this way, even given different coefficients of expansion of overmold 3 and insert part 2, a secure anchoring, and thus increased tightness, is achieved between insert part 2 and overmold 3.

As is shown in FIG. 5, component 1 may be used in an injection valve 100.

FIG. 2 shows an overview of groove 4 according to the present invention inside insert part 2. Groove 4 has a spiral shape having a first end 41 and a second end 42. In addition, groove 4 has, at two edges, an undercut 8, undercut 8 continuing to be present only on one surface at first end 41 and at second end 42.

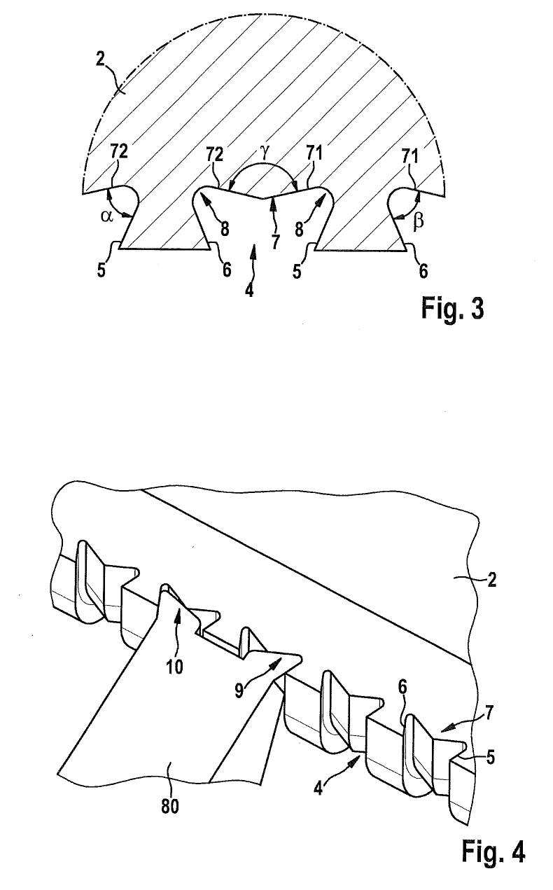

FIG. 3 shows an enlarged representation of groove 4. Here it can be seen that groove 4 has a first edge 5 and a second edge 6. In addition, groove 4 has a floor surface 7 that is bent in the direction of the external side of the groove. Thus, the floor surface has a first region 71 and a second region 72 that form an angle γ to one another. Angle γ has in particular a value of 120°.

An undercut 8 was made both on first edge 5 and on second edge 6 of groove 4. Undercut 8 results in a first angle α between first edge 5 and first region 71 of floor surface 7 of groove 4. Analogously, there results a second angle β between second edge 6 and second region 72 of floor surface 7. The two angles α and β may be acute angles, having in particular a value of 60°. In the above-named alternative having only one undercut, for example in an insert element 2 having a groove 4 that has an undercut only on first edge 5, second angle β is equal to 90°.

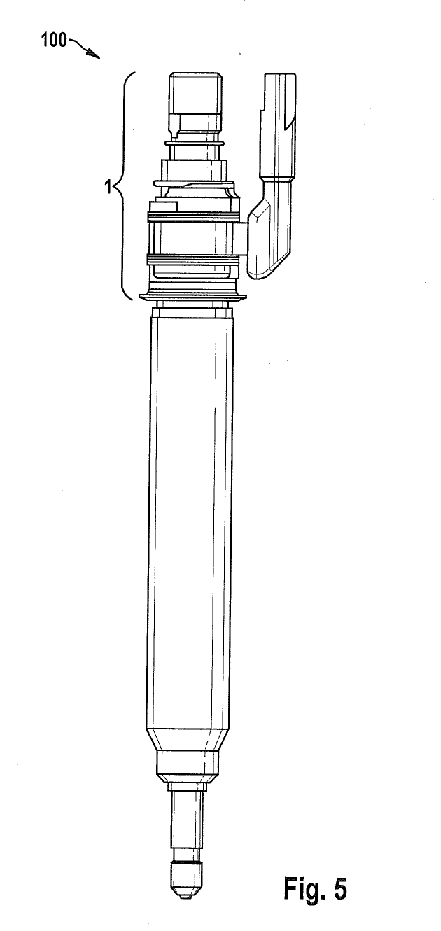

FIG. 4 shows the spatial representation of a segment of insert element 2 having groove 4 according to the present invention. As an example, in addition a tool 80 is shown that has a blade offset of one groove length. Using such a tool, it is therefore possible to produce a two-sided undercut of groove 4. A first blade 9 of tool 80 produces first undercut 8 at first edge 5 of groove 4. At the same time, a second blade 10 of tool 9 produces undercut 8 at second edge 6 of groove 4.

Tool 80 is ideally used to produce a spiral-shaped groove. It can be seen that in this way groove 4, together with undercuts 8 on first edge 5 and second edge 6, can be made very easily and at low cost. Subsequently, plastic can be sprayed into groove 4 produced in this way, so that overmold 3 of insert part 2 is anchored in groove 4.

1-11. (canceled)

12. A component, comprising:
an insert part; and
an overmold that extends at least partly around the insert part;
wherein the insert part has at least one groove, wherein the groove has an undercut at at least one edge, and wherein the overmold at least partly fills the groove.

13. The component of claim 12, wherein the groove is realized with a spiral shape.

14. The component of claim 12, wherein the groove is realized so as to be closed on itself.

15. The component of claim 12, wherein at least one of the edges of the groove forms, in a sectional view, an acute angle with a floor surface of the groove.

16. The component of claim 12, wherein the groove is completely filled by the overmold.

17. The component of claim 12, wherein the insert part is a turned part.

18. The component of claim 12, wherein the insert part is made from a metallic material, and/or the overmold is made of plastic.

19. A method for producing an overmolded component, the method comprising:
providing an insert part;
making a groove having an undercut at at least one edge in a jacket surface of the insert part; and
overmolding at least a region of the insert part with a further material, so that the material at least partly fills the groove.

20. The method of claim 19, wherein the groove is made in the jacket surface of the insert part with a spiral shape or with an annular shape.

21. The method of claim 19, wherein the groove is made with a tool having a blade offset of one or more groove spacings.

22. A fuel injection device for an internal combustion engine, comprising:
a component, including:
an insert part; and
an overmold that extends at least partly around the insert part;
wherein the insert part has at least one groove, wherein the groove has an undercut at at least one edge, and wherein the overmold at least partly fills the groove.

23. The component of claim 12, wherein the groove is realized so as to be closed on itself, in particular having an annular shape.

24. The component of claim 12, wherein both edges of the groove form, in a sectional view, an acute angle with a floor surface of the groove.
